(19) United States
(12) Patent Application Publication
(10) Pub. No.: US 2014/0015489 A1
(43) Pub. Date: Jan. 16, 2014

(54) System and Method Used to Charge the Batteries of a Vehicle

(71) Applicant: Ronald Pardue, Memphis, TN (US)

(72) Inventor: Ronald Pardue, Memphis, TN (US)

(21) Appl. No.: 13/548,165

(22) Filed: Jul. 12, 2012

(51) Int. Cl. H02J 7/16

(52) U.S. Cl. CPC H02J 7/16
USPC 320/123

(57) ABSTRACT

A system used to charge a battery of an electric or gas/electric vehicle is disclosed. The system comprises an axle having a rear suspension, at least one voltage generating device and a voltage regulator. The axle is attached to a wheel of a vehicle. The voltage generating device is fitted in line with and driven by the axle. The voltage regulating device is configured to operate by modulating the small field of current of the voltage generating device to produce a constant voltage at the battery terminals. In one embodiment, a gear box may be used with the system. In another embodiment, a shield may be used to protect the voltage generating devices. A method used to charge a battery of an electric or gas/electric vehicle is also disclosed.

### FIELD

The present disclosure relates generally to a system used to charge the batteries of a vehicle such as an electric vehicle or gas/electric vehicle and a method to use the same. More specifically, the present disclosure relates to a system and method used to continually charge the batteries of an electric or gas/electric vehicle when the vehicle is in motion by utilizing the rotation of wheels to generate voltage which may be used to charge the batteries.

### BACKGROUND

Vehicles designed and used to transport people and cargo have existed for centuries. Such vehicles require a source of energy. Energy to power certain vehicles may be extracted from the surrounding environment; such is the case of a sailboat and a solar powered automobile. Other vehicles may use stored energy as power. Such stored energy may be stored in various forms but must have the ability to be converted on demand. The medium used to store the energy requires an energy density and power density that are sufficient to meet the vehicles' needs.

One common type of stored energy source is fuel. Internal combustion engines are built to burn a specific fuel, such as gasoline, diesel, or ethanol. Automobiles are among the most commonly used engine powered vehicles.

Another common medium for storing energy is batteries. Batteries have numerous advantages including efficiency, simplicity in installation and maintenance, environmental friendliness and utility in a wide range of power levels. Batteries may be used to facilitate the use of electric motors, which also have numerous advantages. The disadvantages of using batteries include low energy densities, short service life and long charging times. The disadvantage of charge time can be resolved by replacing discharged batteries with charged batteries, however, this requires additional hardware and may be impractical for larger batteries. A system used to charge the batteries of an electric vehicle or gas/electric vehicle is needed.

### BRIEF SUMMARY

A system used to charge a battery of an electric or gas/electric vehicle, wherein the vehicle has a plurality of wheels is disclosed. In one embodiment, the system comprises an axle, at least one voltage generating device, and a voltage regulating device. In one embodiment, the axle has a rear suspension. In another embodiment, the axle may be attached to the wheel of the vehicle. The voltage generating device may be fitted in line with and driven by the axle. In one embodiment, the voltage regulating device may be configured to regulate the voltage or current generated by the voltage generating device. The voltage regulator may be connected to and transfer power to the terminals of the battery of the vehicle.

In one embodiment, two voltage generating devices may be fitted in line with and driven by the axle. In another embodiment, three voltage generating devices may be fitted in line with and driven by the axle. Any number of voltage generating devices may be used as desired by one skilled in the art. In a further embodiment, a gear box may be fitted in line with the axle. In still a further embodiment, a shield may be used to protect and shield one or more voltage generating devices.

A system used to charge a battery of an electric or gas/electric vehicle wherein the system comprises at least two axles having a rear suspension is also disclosed. In one embodiment, each axle may be attached to opposite rear wheels of the vehicle. At least one voltage generating device may be fitted in line with and driven by each axle. In one embodiment, a voltage regulating device may be configured to regulate the voltage or current generated by the voltage generating devices. The voltage regulator may be connected to and transfer power to the battery of the vehicle.

In one embodiment, two voltage generating devices may be fitted in line with and driven by each axle. In another embodiment, three voltage generating devices may be fitted in line with and driven by each axle. Any number of voltage generating devices may be used as desired by one skilled in the art. In a further embodiment, a gear box may be fitted in line with each axle. In still a further embodiment, a shield may be used to protect and shield one or more voltage generating devices.

A method used to charge a battery of an electric or gas/electric vehicle is also disclosed. In one embodiment, the method comprises (a) attaching a system used to charge a battery of an electric or gas/electric vehicle to a vehicle, wherein the vehicle has a plurality of wheels, wherein the system comprises: (i) an axle attached to a wheel of the vehicle; (ii) at least one voltage generating device fitted in line with and driven by the axle; and (iii) a voltage regulating device configured to regulate the voltage generated by the voltage generating device, wherein the voltage regulator is connected to and transfers power to the terminals of the battery of the vehicle; and (b) driving the vehicle.

In one embodiment, two voltage generating devices may be fitted in line with and driven by the axle. In another embodiment, three voltage generating devices may be fitted in line with and driven by the axle. Any number of voltage generating devices may be used as desired by one of skill in the art. In a further embodiment, a gear box may be fitted in line with the axle. In still a further embodiment, a shield may be used to protect and shield one or more voltage generating devices.

### BRIEF DESCRIPTION OF THE DRAWINGS

The present disclosure will be better understood by reference to the following detailed description when considered in conjunction with the accompanying drawings wherein:

FIG. 1 is a perspective view of a system used to charge the batteries of an electric or gas/electric vehicle according to an example embodiment of the present invention. FIG. 1 includes a close up perspective view of a voltage generating device attached to housing.

FIG. 2 is a perspective view of the armature connection between two voltage generating devices.

FIG. 3 is a top perspective view of the interior of a gear box.

FIG. 4 is a side cross sectional perspective view of a gear box.

FIG. 5 is a perspective view of an axle with rear suspension without the system used to charge the batteries of a vehicle attached.

FIG. 6 is a perspective view of an axle with rear suspension with the system used to charge the batteries of an electric or gas/electric vehicle attached, according to another example embodiment of the present invention. FIG. 6 also includes a close up perspective view of the axle that is machined down to the size of the gearbox and armature shafts, with multiple voltage generating devices not shown in order to show the axle.

FIG. 7 is a perspective view of a system with a protective shield, according to another example embodiment of the present invention.

FIG. 8 is a perspective side view of a multi rear wheel vehicle capable of supporting multiple systems used to charge the batteries of an electric or gas/electric vehicle.

### DETAILED DESCRIPTION

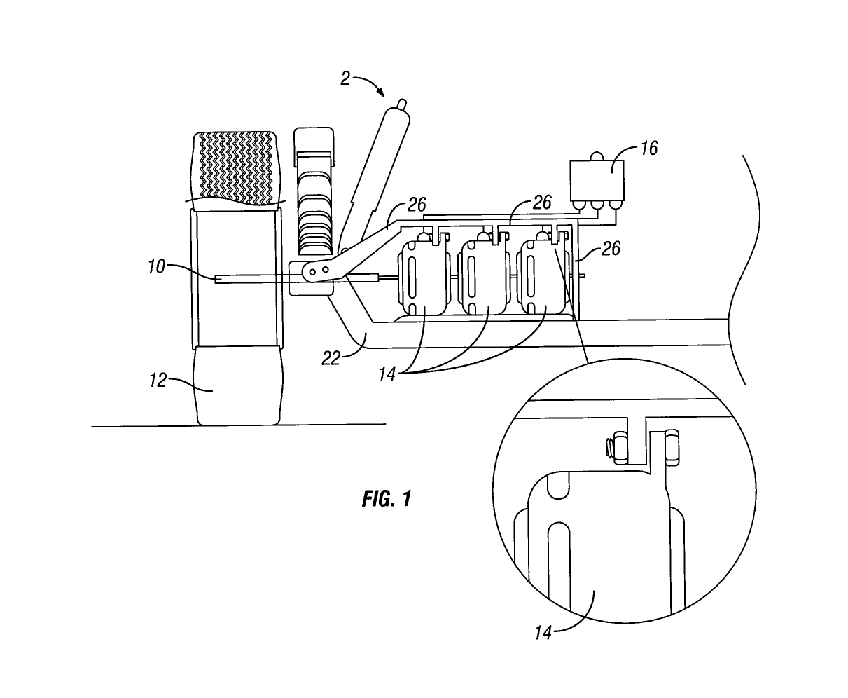

Referring to FIG. 1, a system 2 used to charge the battery of an electric or gas/electric vehicle is disclosed. System 2 utilizes the rotation of the wheel to generate electrical power to charge batteries of a vehicle such as an electric or gas/electric vehicle. In one embodiment, system 2 may be used by any vehicle that uses batteries to provide energy and power to the vehicle. Such vehicles may include, but are not limited to, electric vehicles, gas/electric vehicles, all-terrain vehicles and golf carts.

In one embodiment, system 2 comprises axle 10. Axle 10 may be a free-wheeling rear axle. In one embodiment, axle 10 may comprise a central shaft used to rotate a wheel. In another embodiment, axle 10 may comprise a central shaft and a housing encasing the shaft. Axle 10 may vary as desired by one skilled in the art. In one embodiment, axle 10 may be fixed to wheel 12. The axle 10 may be bolted to the wheel and may rotate with the wheel. Axle 10 may be attached to the wheel by any other means as desired by one of skill in the art.

In one embodiment, voltage generating devices 14 are fitted in line with and driven by the axle 10 of electric or gas/electric vehicles. In one embodiment, a voltage generating device 14 may be an alternator. In another embodiment, a voltage generating device 14 may be a generator. Voltage generating devices 14 capture the power generated by the rotation of the wheels on the surface of the road. In one embodiment, a voltage generating device 14 may have two armatures 18 protruding from opposite ends.

The power generated by voltage generating device 14 is regulated by voltage regulating device 16 and used to charge the batteries of electric, gas/electric or other driven vehicles. The voltage regulating device 16 operates by modulating the small field of current of the voltage generating device 14 to produce a constant voltage at the terminals of the battery of the vehicle. In one embodiment, the voltage regulating device 16 may be a discrete device mounted in the vehicle. In another embodiment, the voltage regulating device 16 may be incorporated into the voltage generating device 14. In a further embodiment, voltage regulating device 16 may be a function of the electronic control unit of a vehicle. The constant charging of the batteries increases the mileage of such vehicles. System 2 utilizes the already present wheel rotation of moving vehicles which exerts minimum resistance on the electrical operation. Because the diameter of wheel 12 is greater than the diameter of axle 10, there is a great leverage advantage to turn these ball-bearing pieces of equipment with very little resistance, therefore not causing much horsepower energy to be used from the main electric or gas/electric motor of the vehicle for this system.

Referring to FIG. 1, in one embodiment, system 2 may comprise at least one voltage generating device 14. In another embodiment, system 2 may comprise two voltage generating devices 14. In another embodiment, system 2 may comprise three voltage generating devices. Any number of voltage generating devices 14 may be used as desired by one of skill in the art, dependent on the dimensions of the vehicle.

In one embodiment, vehicles that utilize system 2 may also use a plug in charging system as an alternative to charging an electric or gas/electric vehicle.

In one embodiment, axle 10 has a rear suspension 22 and housing 26, which support voltage generating devices 14. In one embodiment, voltage generating devices 14 are bolted to housing 26 (shown in FIG. 1). Voltage generating devices 14 may be attached to housing 26 by other forms of attachment as desired by one of skill in the art. Referring now to FIG. 6, in one embodiment, the diameter of axle 10 may narrow as axle 10 extends away from wheel 12 to equal the diameter of the armature shaft 18 of the voltage generating device 14. In one embodiment, axle 10 protrudes out of the back of housing 26 through a seal approximately an inch and three-quarters and drilled in the end for a lockpin. The dimensions and configuration of housing 26 may vary as desired by one skilled in the art.

Referring now to FIGS. 3 and 4, in one embodiment, gearbox 30 may be used to increase the Rotations Per Minute (RPMs) generated by system 2. In one embodiment, gearbox 30 may be a six-to-one ratio gearbox. Other ratio gearboxes may be used as desired by one of skill in the art. In one embodiment, gearbox 30 is attached to axle 10 and fitted in line with the voltage generating devices 14.

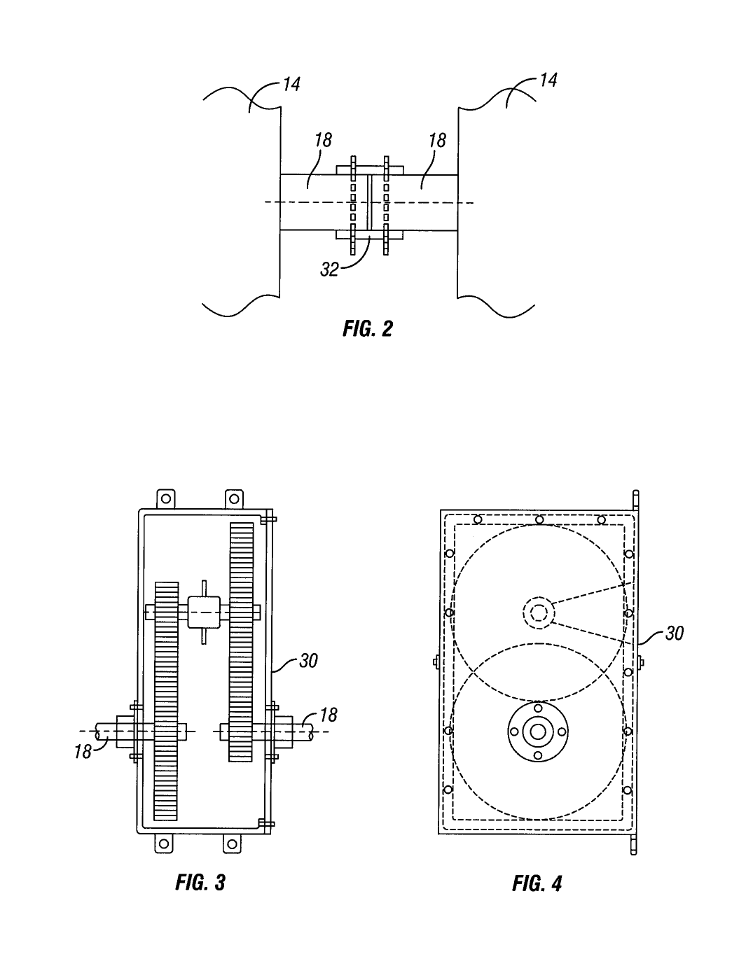

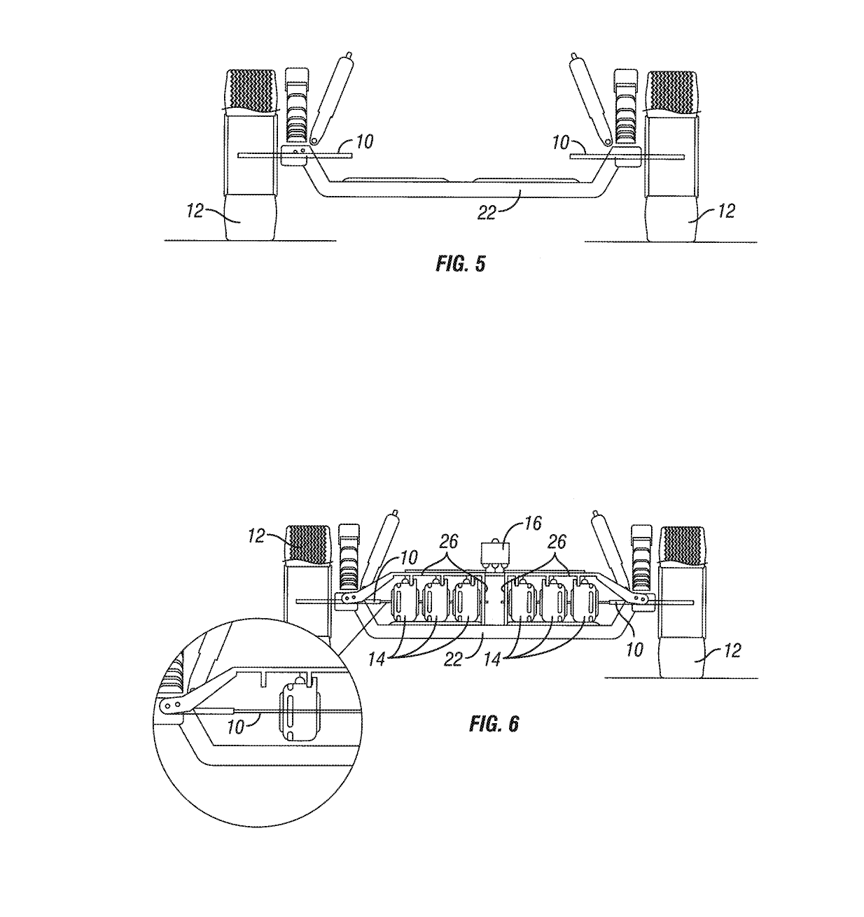

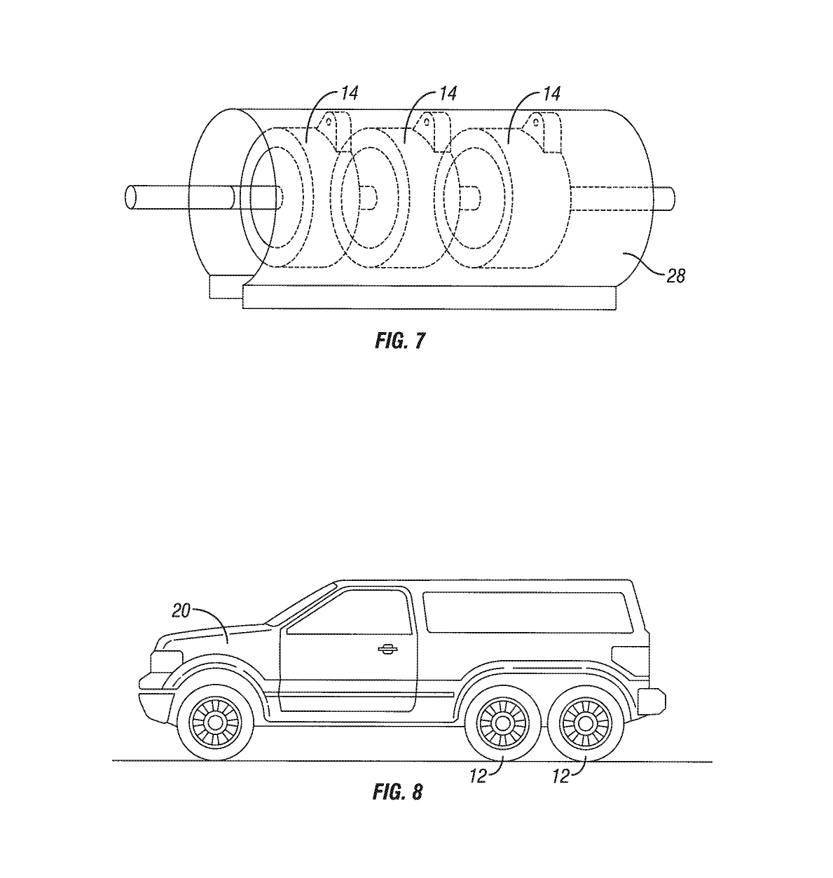

In one embodiment, gearbox 30 and voltage generating devices 14 may comprise an armature shaft 18 that protrudes an inch and three-quarters from each end and is drilled for a lockpin (shown in FIG. 2). A steel slip-on sleeve 32 will allow two shafts 18 to be aligned and connected. The sleeve has two lock holes on each end which would align with the holes in the shafts 18 and axle 10. These two shafts may be locked together and this would be repeated to allow for three or four alternators on each side of the suspension system. In one embodiment, this may be repeated on the opposite side to allow for six to eight voltage generating devices 14. Referring to FIG. 6, when multiple axles 10 are used, one on each rear wheel, axles 10 will not be joined at the center of the suspension system due to the different turning radiuses of the inside and outside rear wheels. Voltage generating devices 14 may face inward or outward so that the alternators will normally turn in a clockwise revolution. Voltage generating devices 14 will be regulated either internally or externally and connected to standard batteries or higher technology-type batteries. Two or more voltage generating devices 14 may be manufactured as one unit for ease of installation.

System 2 when used on multi-rear axles will double charging capacity of system 2 (see FIG. 8), thus allowing system 2 to be used with larger vehicles.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

What is claimed is:

1. A system used to charge a battery of an electric or gas/electric vehicle, wherein the vehicle has a plurality of wheels, the system comprising:
a. an axle having a rear suspension and housing, wherein the axle is attached to a wheel of the vehicle;
b. at least one voltage generating device fitted in line with and driven by the axle, wherein the voltage generating device is attached to the housing and rear suspension; and
c. a voltage regulating device configured to operate by modulating the small field of current of the voltage generating device to produce a constant voltage at the battery terminals.

2. The system of claim 1 wherein two voltage generating devices are fitted in line with and driven by the axle.

3. The system of claim 1 wherein three voltage generating devices are fitted in line with and driven by the axle.

4. The system of claim 1 wherein a gear box is fitted in line with the axle.

5. The system of claim 1 wherein a shield is used to protect the at least one voltage generating device.

6. A system used to charge a battery of an electric or gas/electric vehicle, wherein the vehicle has a plurality of wheels, the system comprising:
a. at least two axles attached to a rear suspension and housing, wherein each axle is attached to a wheel of the vehicle;
b. at least one voltage generating device fitted in line with and driven by the axle; wherein the voltage generating device is attached to the housing and rear suspension; and
c. a voltage regulating device configured to operate by modulating the small field of current of the voltage generating device to produce a constant voltage at the battery terminals.

7. The system of claim 6 wherein two voltage generating devices are fitted in line with and driven by each axle.

8. The system of claim 6 wherein three voltage generating devices are fitted in line with and driven by each axle.

9. The system of claim 6 wherein a gearbox is fitted in line with each axle.

10. The system of claim 6 wherein a shield is used to protect the voltage generating devices.

11. A method used to charge a battery of an electric or gas/electric vehicle wherein the method comprises:
a. attaching a system used to charge a battery of an electric or gas/electric vehicle to a vehicle, wherein the vehicle has a plurality of wheels, wherein the system comprises: (i) an axle attached to a wheel of the vehicle; (ii) at least one voltage generating device fitted in line with and driven by the axle; and (iii) a voltage regulating device configured to operate by modulating the small field of current of the voltage generating device to produce a constant voltage at the battery terminals; and
b. driving the vehicle.

12. The method of claim 11 wherein the system comprises two voltage generating devices fitted in line with and driven by the axle.

13. The method of claim 11 wherein the system comprises three voltage generating devices fitted in line with and driven by the axle.

14. The method of claim 11 wherein the system comprises a gear box fitted in line with the axle.

15. The method of claim 11 wherein the system comprises a shield used to protect the voltage generating device.
